(19) United States
(12) Patent Application Publication
(10) Pub. No.: US 2026/0067826 A1
(43) Pub. Date: Mar. 5, 2026

(54) MULTI-MODAL MODEM

(71) Applicant: T-Mobile USA, Inc., Bellevue, WA (US)

(72) Inventors: Joseph Reid Baird, Kent, WA (US); Wilfred Ivan Tucker, Centennial, CO (US); Barry Robert Butterklee, Sammamish, WA (US); Chris A. Cholas, Denver, CO (US); Dileepa Prabhakar, Edmonds, WA (US)

(21) Appl. No.: 18/823,370

(22) Filed: Sep. 3, 2024

(51) Int. Cl. H04W 52/06; H04W 52/18

(52) U.S. Cl. CPC H04W 52/06; H04W 52/18

(57) ABSTRACT

Systems and methods for operating a multi-modal modem are described herein. In some examples. A modem may operate in one mode of operation while the network communication device detects a first environmental condition and another mode of operation in a second environmental condition. One mode of operation may be a higher power transmission mode, whereas the other mode of operation may be a lower power transmission mode. An environmental condition can include a detected presence of a user equipment, an availability of a particular power source, or a potential security issue, for example.

### BACKGROUND

Modems are often used in locations to provide communication capabilities at the location. Modems are most often used to facilitate the connection of a home or office to various services provided through an Internet connection. Conventional modems use various technologies to facilitate that connection, including, but not limited to, digital subscriber line (DSL), cable, fiber optic networks, cellular, and satellite communications. Some of the technologies, such as DSL, cable, and fiber, require a physical connection to the modem at the location to provide the connection, other technologies, such as cellular and satellite, use wireless transmissions signals received and transmitted by a modem to provide the connection. The selection of which of the technologies to use may depend on a subscription price, bandwidth capabilities, and, in some instances, whether or not the service is available at the location.

Conventional modems that use these connection technologies are typically designed for that specific technology. For example, a DSL modem has connections and operating system designed to use the DSL technology, meaning the modem likely will not have the ability to use cable or fiber. Further, conventional modems often operate in a manner indifferent to the environment in which the modem is being used. For example, conventional modems do not change an operational configuration if no individuals are present to use the modem. The modem maintains the same configuration, waiting for a device or user to begin the use of the modem.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communication network environment using an environmentally aware, multiple mode modem, in accordance with examples of the disclosure.

FIG. 2 is a flow diagram of an illustrative process used by an environmentally aware, multiple mode modem to switch from a first mode to a second mode based on the receipt of an environmental condition, in accordance with examples of the disclosure.

FIG. 3 is a schematic diagram of illustrative components in an example environmentally aware, multiple mode modem, in accordance with examples of the disclosure.

### DETAILED DESCRIPTION

### Overview

It should be understood that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. This disclosure is directed in part to systems and techniques for providing and using an environmentally aware, multiple-mode modem. As used herein, “environmentally aware” means that the operation of the modem is modified based on one or more conditions in which the modem operates. For example, a condition may be the absence, or presence, of one or more registered devices within a monitoring area. The monitoring area may be a location such as a home, office, or other geographic region, whereby the detection of a user equipment within the monitoring area can be used to determine a particular mode of operation of the modem. In another example, a condition may be the presence, or absence, of one or more sources of power. For example, the modem may operate in one mode when the modem is using a battery as a power source and in another mode when the modem is using an alternating current power source provided by a power company. In a still further example, the condition may be the receipt of a notification from a sensor such as an audio sensor or a motion sensor indicating a possible security issue.

As used herein, a “mode” refers the manner in which the modem operates. For example, a mode may be a higher power mode using a preferred, first, or primary source of power, e.g., alternating power (AC power), and a lower power mode using a secondary or second source of power, e.g., battery power or other direct current (DC power) or stored power. In another example, another mode may use a lower power communication technology, such as a lower power radio frequency transceiver and antenna, and a second mode may use a higher power communication technology such as a high power transceiver (such as a cellular transceiver) and antenna system. For example, an environmentally aware, multiple-mode modem, according to some examples, may use cellular broadband network communication technology in a high-power mode. The technology may include the use of networks that facilitate wireless communications services for one or more wireless communications devices. Such networks include networks that support one or more 3GPP standards, including, but not limited to, Long Term Evolution (LTE) networks (e.g., 4G LTE networks) and New Radio (NR) networks (e.g., 5G NR networks). In some examples, the environmentally aware, multiple-mode modem, according to some examples, may use short message or text technology in a low-power mode, whereby the modem transmits short messages to a low orbit satellite using a satellite communication capable transceiver and antenna capable of communicating with a satellite using technologies such as satellite text messaging or other satellite communication protocols. It should be noted that in some examples, the environmentally aware, multiple-mode modem may use various types of communication technologies in both a low-power and high-power mode. For example, terrestrial communication technologies may not be available. In this example, the environmentally aware, multiple-mode modem may use non-terrestrial communication technologies in both modes, examples of which may include, but are not limited to, satellite and high orbit (e.g., hot air balloon) communication technologies.

In some examples, the environmentally aware, multiple-mode modem according to some examples may operate in one mode when a registered user equipment (or a user) is present within a monitoring zone of the environmentally aware, multiple-mode modem. In this example, the mode may be an “operational” mode, whereby the modem is providing communication services to one or more users/systems as well as monitoring services for systems such as security systems, Internet of Things (IoT) devices, and the like. Continuing with the same example, a second mode may be a “standby” mode. In this mode, the modem is not needed to provide communication capabilities to users because the users are not present in the space or location serviced by the modem. Thus, the full functionality of the modem is not needed. In this example, to reduce the amount of power used by the modem maintaining a broadband connection when the connection is not needed, as well as release network resources for use by other modems, the modem pauses the broadband connection. In some examples, the modem switches to a relatively lower bandwidth mode(s) of operation than relatively higher bandwidth mode(s) of operation. The relatively lower bandwidth mode(s) of operation may use relatively lower power transceivers and communication technology. Similarly, relatively higher bandwidth mode(s) of operation may use relatively higher power transceivers and communication technology. For example, the mode may not be needed if the modem is only being used to monitor communications from IoT devices (e.g., no users present in the monitoring area).

In some examples, while in another mode, the modem may receive an environmental condition that indicates a potential requirement to switch from the other mode of operation to the prior mode of operation. The environmental condition may include, but is not limited to, the availability of a non-battery source of power, the detection of the presence of a user equipment within a monitoring area, a notice from a security sensor (e.g., audio, motion, or video detector) indicating the potential presence of a security issue, and the like. The modem determines if the environmental condition requires the switch from the other mode back to the prior mode switches if required.

Illustrative environments, signal flows, and techniques for implementing systems and methods for using an environmentally aware, multiple mode modem are described below. However, the described systems and techniques may be implemented in other environments.

### Illustrative System Architecture

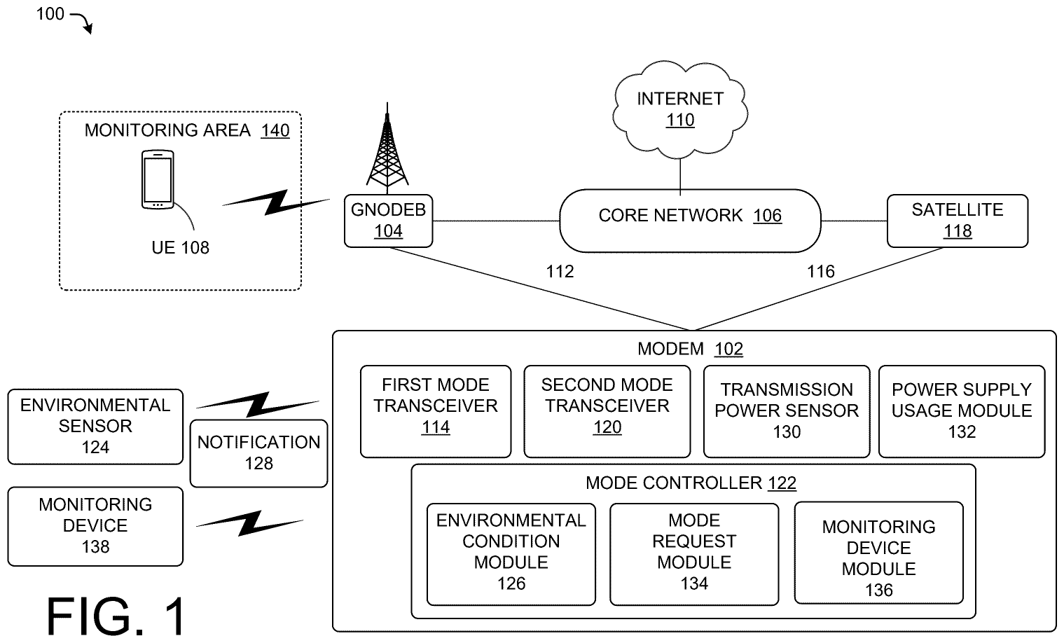

FIG. 1 is a schematic diagram of an illustrative wireless network environment 100 in which the disclosed systems and techniques may be implemented, in accordance with examples of the disclosure. The environment 100 may include a modem 102 that communicates wirelessly with a gNodeB 104. While referred to as an “gNodeBs” for explanatory purpose herein, the gNodeB 104 may be any type of base station, including, but not limited to, any type of BTS, NodeB, eNodeB, gNodeB, etc. The gNodeB 104 may communicate with other components and functions in a core network 106. The core network 106 may be any one or more networks that facilitate communications between particular devices, components, and/or functions of various types in the core of a wireless communications network that may facilitate communication between computing device and/or mobile devices, such as a user equipment (UE) 108. Various connections between components and functions in the core network 106 may be wired, wireless, or a combination thereof. The components and functions described herein may be implemented as physical devices, as software components executing on one or more computing devices, any combination thereof. In various embodiments, the core network 106 may facilitate the establishment of communications sessions for one or more wireless devices, such as the UE 108, and/or services (not shown) provided through an Internet 110.

In the example illustrated in FIG. 1, a first mode of the modem 102 comprises a cellular communication connection 112 with the core network 106 through the gNodeB 104. In the first mode, the modem 102 uses a first mode transceiver 114. If the first mode is the use of a cellular network, the first mode transceiver 114 may include a cellular antenna capable of communicating with the core network 106 through the gNodeB 104. It should be understood that if the first mode comprises a different communication technology, such as satellite, DSL, cable, or fiber optic, the first mode transceiver 114 may be an interface capable of establishing communications with the core network 106 using the connection.

Further in the example illustrated in FIG. 1, a second mode of the modem 102 comprises a satellite communication connection 116 with the core network 106 through a satellite 118. In the second mode, the modem 102 uses a second mode transceiver 120. The second mode transceiver 120 may include a satellite antenna capable of communicating with the satellite 118. It should be understood that if the second mode comprises a different communication technology, such as cellular, DSL, cable, or fiber optic, the second mode transceiver 120 may be an interface capable of establishing communications with the core network 106 using the connection. Further, it should be understood that the first mode and the second mode may use the same communication technology. For example, the first mode may be a 5G cellular technology while the second mode may be a 2G/3G/4G/4G LTE cellular technology. In some further examples, the first mode may be a higher power transmission and the second mode may be a lower power transmission using the same communication technology.

As discussed above, the modem 102 uses environmental conditions to determine in which mode the modem 102 will operate. The modem 102 includes a mode controller 122 configured to receive environmental condition inputs and based on those inputs, provide an instruction to the modem 102 to operate in a first mode or a second mode. In some examples, the modem 102 may be in communication with environmental sensor 124. The number and type of the environmental sensors is merely exemplary, one or more than two environmental sensors may be used. An environmental condition module 126 of the mode controller 122 may be configured to receive a notification 128 from the environmental sensor 124 indicating an environmental condition. For example, the environmental sensor 124 may be a security system having a motion detector. The motion detector may detect a motion and transmit to the mode controller 122 the notification 128 indicating the detection of movement. The environmental condition module 126 is configured to receive the notification 128 and, based on the notification indicating the environmental condition, determine if the modem 102 is to operate in a first mode or a second mode of operation.

If the modem 102 is operating in the first mode of operation and the notification 128 is received indicating an environmental condition, the mode controller 122 causes the modem 102 to maintain the first mode of operation if the environmental condition module 126 determines that the second mode of operation is not required based on the environmental condition. If the modem is operating in the first mode of operation and the environmental condition module 126 determines that the second mode of operation is required based on the environmental condition, the mode controller 122 causes the modem 102 to switch to the second mode of operation. In some examples, the notification 128 may indicate that the environmental condition has cleared (or changed). If the modem 102 is operating in the second mode of operation and the notification 128 is received indicating the environmental condition has cleared, the mode controller 122 causes the modem 102 to maintain the second mode of operation if the environmental condition module 126 determines that the second mode of operation is required even if the environmental condition has cleared. If the modem is operating in the second mode of operation and the environmental condition module 126 determines that the first mode of operation is required based on the environmental condition clearing, the mode controller 122 causes the modem 102 to switch to the first mode of operation.

As further noted above, another environmental condition may be the transmission power required to communicate. For example, the modem 102 may use a transmission power sensor 130 to detect the power required to communicate with the gNodeB 104 and provide the information as the notification 128 to the environmental condition module 126. The environmental condition module 126 may determine that the power requirement is greater than a predetermined power level, and thus, cause the modem 102 to switch from a first mode to the second mode. In another example, an environmental condition may be the type of power source used by the modem 102. For example, the modem 102 may have available for use power provided by a third-party source, such as alternating current from an electrical company. In another example, the modem 102 may have available, potentially as a back-up or alternate to the alternating current from the electrical company, battery power, solar power, wind power, or power from a generator. In some examples, an environmental condition may include a battery operational condition whereby the network communication device uses the battery as a primary source of power to the network communication device. In some examples, it may be preferable for the modem 102 to operate in a manner that uses a minimal amount of power when using battery power or power from a generator. In this example, a power supply usage module 132 may provide the notification 128 to the environmental condition module 126 indicating that the power being used by the modem 102 is the alternate power, thus requiring a second, low power mode of operation. In such an example, the power supply usage module 132 may determine that the modem 102 is using the alternate power when an electronic control logic of an alternate power source (e.g., a battery, a generator, etc.) sends a communication message to the power supply usage module 132 indicating that the alternate power source is supplying power to the modem 102.

In some examples, prior to causing the modem 102 to switch from one mode of operation to another mode of operation, the mode controller 122 may perform one or more functions. For example, the environmental sensor 124 may be a security device such as a motion detector of a security system. Upon the detection of motion, the security device, e.g., the environmental sensor 124, may issue a warning or notice to modem 102 in the form of the notification 128. Although the security system may detect motion, potentially indicating an intruder or other security issue, it may be preferable to request a confirmation from a user or other entity that the modem 102 is permitted to switch from one mode to another mode. Thus, a function may be the use of a monitoring device module 136. In some examples, the monitoring device module 136 instructs a monitoring device 138 to provide additional data. For example, the monitoring device 138 may be a drone having a camera that is powered on and instructed by the monitoring device module 136 to take arial images, video, and/or audio to confirm the motion detected by the security sensor. The additional data provided by the monitoring device 138, in this case a drone, may be transmitted to a user. The mode controller 122 may in conjunction or in the alternate pursuant to the receipt of the notification 128 by the environmental sensor 124 transmit a request by the mode request module 134 to request permission using a permission notification to cause the modem 102 to switch the mode of operation.

In another example, the environmental condition used to determine if the modem 102 is to operate in one mode of operation or another mode of operation may be based on the presence or absence of one or more users and/or user equipment, such as the user equipment 108. In this example, the mode may be the capability of using the first mode transceiver 114 at the full capacity of the first mode transceiver and the second mode may be a mode in which the first mode transceiver 114 is operated at less than a full capability. In the example illustrated in FIG. 1, a monitoring area 140 may be used by the modem 102 to determine if the modem 102 is to operate in a higher bandwidth mode or a lower bandwidth mode. The monitoring area 140 may be a location such as a home, office, or other geographic region. It should be noted that although the monitoring area 140 is illustrated as having a boundary indicating a particular geographic area, the monitoring area 140 may be based on other factors such as signal strength or cellular/satellite coverage, as described below. Further, although one monitoring area 140 is illustrated, more than one monitoring area 140 for more than one user equipment may be used and are considered to be within the scope of the presently disclosed subject matter. As noted above, the monitoring area 140 may also be a predetermined distance or a signal strength from a network communication device such as the modem 102, the gNodeB 104, the satellite 118, and the like. At a distance greater than the predetermined radius or signal strength, the modem 102 may operate in one mode of operation and at a distance at or less than the predetermined radius or signal strength, the modem 102 may be operated in another mode of operation. The monitoring area 140 may also extend to a time of day or date. In the example of the monitoring area 140 being a home, wherein the modem 102 is used by the user of the UE 108 to provide Internet 110 connectivity, the modem 102 may detect that the UE 108 has entered the monitoring area 140. The modem 102, detecting that the UE 108 has entered the monitoring area 140, may determine that a particular mode is required. The UE 108 may be registered with, or otherwise identified, with the modem 102 to facility the switch between modes.

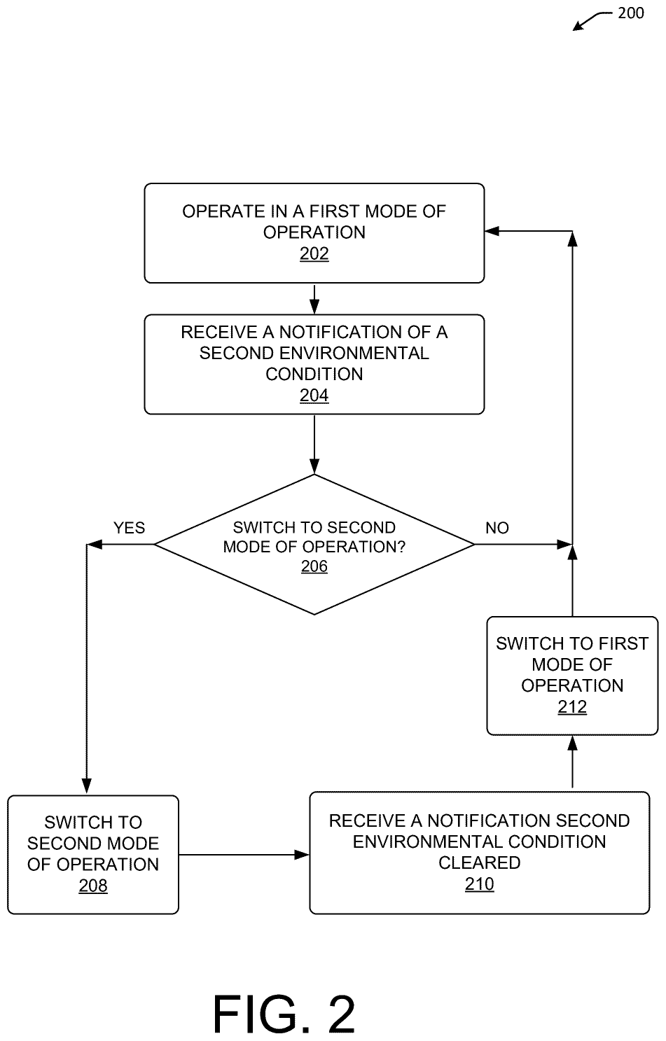

FIG. 2 shows a flow diagram of an illustrative process 200 for restoring user data repository communication connections using designated attempt initiators and recipients, according to examples of the presently disclosed subject matter. The process 200 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 200 may be described with reference to the wireless network environment 100 of FIG. 1, however other environments may also be used.

At block 202, the modem 102 is operating in a first mode of operation. The modem 102 uses environmental conditions to determine in which mode the modem 102 will operate. The mode controller 122 receives environmental condition inputs and based on those inputs, provides an instruction to the modem 102 to operate in a first mode or a second mode.

At block 204, the modem 102 receives a notification 128 of a second environmental condition. The modem 102 includes the mode controller 122 configured to receiving environmental condition inputs and based on those inputs, provide an instruction to the modem 102 to operate in a first mode or a second mode. In some examples, the modem 102 may be in communication with environmental sensor 124. The number and type of the environmental sensors is merely exemplary, one or more than two environmental sensors may be used. The environmental condition module 126 of the mode controller 122 may be configured to receive a notification 128 from the environmental sensor 124 indicating an environmental condition. For example, the environmental sensor 124 may be a security system having a motion detector. The motion detector may detect a motion and transmit to the mode controller 122 the notification 128 indicating the detection of movement. The environmental condition module 126 is configured to receive the notification 128 and, based on the notification indicating the environmental condition, determine if the modem 102 is to operate in a first mode or a second mode of operation.

At block 206, the modem 102 determines if the modem 102 is to switch to the second mode based on the received notification. In some examples, the notification is sufficient to cause the switch. In other examples, the modem 102 may perform one or more secondary functions before switching. For example, pursuant to the receipt of the notification 128 by the environmental sensor 124, the modem 102 may transmit a request by the mode request module 134 to request permission to cause the modem 102 to switch the mode of operation. The permission may be transmitted to a user, or an entity designed to allow the switching of the modem 102 from the first mode to the second mode. In some examples, the monitoring device module 136 instructs a monitoring device 138 to provide additional data. For example, the monitoring device 138 may be a drone that is powered on and instructed by the monitoring device module 136 to take arial video and/or audio to confirm the motion detected by the security sensor. The additional data provided by the monitoring device 138, in this case a drone, may be transmitted to a user as part of the request for permission to switch from the first mode to the second mode.

If at block 206 the modem 102 determines that a switch to the second mode is not required, the modem 102 continues to operate at block 202. If at block 206 the modem 102 determines that the switch from the first mode to the second mode is required, at block 208, the modem 102 switches from the first mode to the second mode. In some examples, the modem 102 may be maintained in the second mode until the environmental condition(s) that prompted the switch to the second mode have cleared. At block 210, the modem 102 receives a notification that the environmental condition(s) have cleared. At block 212, the modem 102 switches to the first mode of operation and continues to operate at block 202.

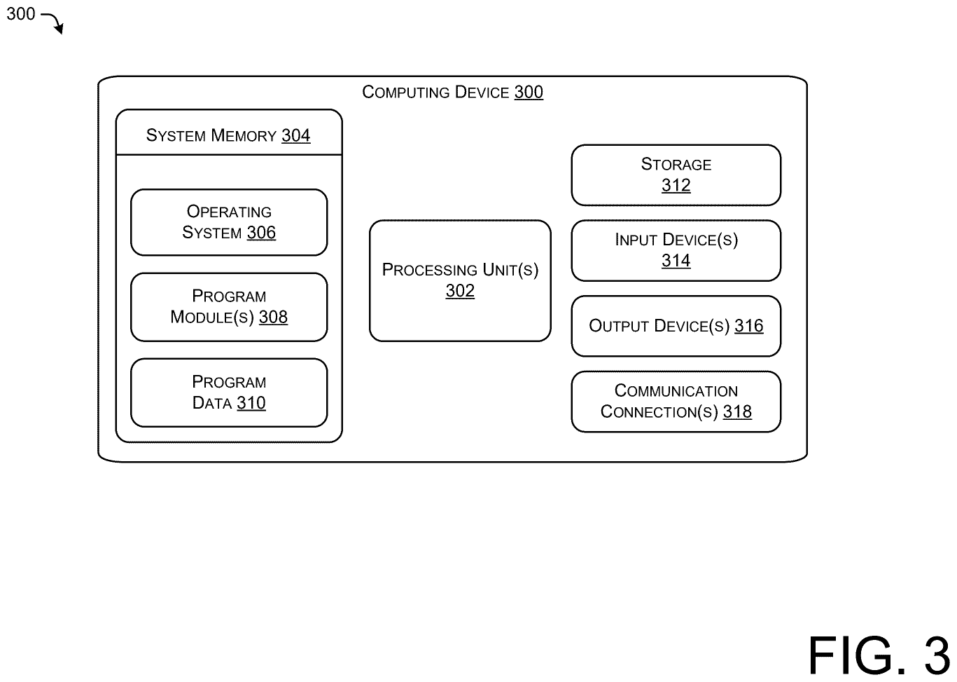

FIG. 3 is a component level illustration of a computing device 300, such as the modem 102, in accordance with some examples of the present disclosure. The modem 102 can be used separate from or in conjunction with other components of the network 106 to implement various components of a core network, a base station, and/or any servers, routers, gateways, gateway elements, administrative components, etc. that can be used by a communication provider.

In various embodiments, the modem 102 can include one or more processing units 302 and system memory 304. Depending on the exact configuration and type of computing device, the system memory 304 can be volatile (such as RAM), non-volatile (such as ROM, flash memory, etc.) or some combination of the two. The system memory 304 can include an operating system 306, one or more program modules 308, and can include program data 310. In some examples, the program modules 308 may include the mode controller 122, the environmental condition module 126, the mode request module 134, and/or the monitoring device module 136.

The system memory 304 may be secure storage or at least a portion of the system memory 304 can include secure storage. The secure storage can prevent unauthorized access to data stored in the secure storage. For example, data stored in the secure storage can be encrypted or accessed via a security key and/or password. The program modules can include instructions to execute one or more blocks described in FIGS. 1 and 2. The modem 102 can also include additional data storage devices (removable and/or non-removable) such as, for example, magnetic disks, optical disks, or tape. Such additional storage is illustrated in FIG. 3 by storage 312.

Non-transitory computer storage media (or computer-readable media) of the modem 102 can include volatile and nonvolatile, removable and non-removable media implemented in any method or technology for storage of information, such as computer readable instructions, data structures, program modules, or other data. The system memory 304 and storage 312 are examples of computer readable storage media. Non-transitory computer readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information, and which can be accessed by modem 102. Any such non-transitory computer readable storage media can be part of the modem 102.

In various embodiments, any or all of the system memory 304 and storage 312 can store programming instructions which, when executed, implement some or all of the functionality described above as being implemented by one or more systems configured in the environment 100 and/or components of the network 106.

The modem 102 can also have one or more input devices 314 such as a keyboard, a mouse, a touch-sensitive display, voice input device, etc. The modem 102 can also have one or more output devices 316 such as a display, speakers, a printer, etc. can also be included. The modem 102 can also contain one or more communication connections 318 that allow the device to communicate with other computing devices using wired and/or wireless communications using transceivers. In some examples, the communication connections 318 may include the first mode transceiver 114 and/or the second mode transceiver 120.

### Example Clauses

The following paragraphs describe various examples. Any of the examples in this section may be used with any other of the examples in this section and/or any of the other examples or embodiments described herein.
1: A method of operating a network communication device, the method comprising: operating in a first mode of operation while the network communication device detects a first environmental condition; receiving, at the network communication device, a notification of a second environmental condition; determining, by the network communication device and based on the second environmental condition, if the network communication device is to operate in a second mode of operation; and maintaining the first mode of operation if the network communication device determines the second mode of operation is not required based on the second environmental condition; and switching the network communication device from the first mode of operation to the second mode of operation upon the network communication device determining that the second environmental condition requires the second mode of operation.
2: The method of paragraph 1, wherein the first mode of operation is a lower power mode whereby the network communication device provides a relatively lower bandwidth for communication.
3: The method of paragraph 2, wherein the relatively lower bandwidth for communication comprises using a low power transceiver.
4: The method of paragraph 2, wherein the relatively lower bandwidth for communication comprises satellite communication.
5: The method of paragraph 4, wherein the satellite communication comprises satellite text messaging.
6: The method of paragraph 1, wherein the second mode of operation is a higher power mode whereby the network communication device provides a relatively higher bandwidth for communication.
7: The method of paragraph 6, wherein the relatively higher bandwidth for communication comprises using high power transceiver.
8: The method of paragraph 1, wherein the first environmental condition comprises a battery operational condition whereby the network communication device uses a battery as a primary source of power to the network communication device.
9: The method of paragraph 1, further comprising: transmitting a notification to a user equipment to request permission to switch from the first mode of operation to the second mode of operation upon receiving the notification of the second environmental condition and determining that the second environmental condition requires the second mode of operation, wherein the switching includes switching the network communication device from the first mode of operation to the second mode upon, in response to the notification to request permission, receiving a permission notification from the user equipment to permit the switching of the network communication device from the first mode of operation to the second mode of operation.
10: The method of paragraph 1, wherein the second environmental condition comprises a power source operational condition wherein the network communication device uses alternating current power or direct current power from a third-party power source.
11: The method of paragraph 1, further comprising: registering a user equipment with the network communication device, wherein the registering comprises providing a location of the user equipment to the network communication device; wherein the first mode of operation is used by the network communication device when the user equipment is a distance greater than a predetermined radius or signal strength from the network communication device; and wherein the second mode of operation is used by the network communication device when the user equipment is a distance at or less than the predetermined radius or signal strength from the network communication device.
12: The method of paragraph 1, wherein the second environmental condition comprises a warning from a security device.
13: The method of paragraph 12, further comprising initializing a monitoring device to monitor an area based on the receiving the warning from the security device, wherein the monitoring device comprises a drone having a camera to provide images or video of the area.
14: The method of paragraph 13, wherein the monitoring device further comprises one or more audio or motion sensors to monitor the area.
15: The method of paragraph 1, further comprising: receiving, at the network communication device, a notification that the second environmental condition has cleared; and switching from the second mode of operation to the first mode of operation.
16: A network communication device, comprising: one or more processors; one or more transceivers; and non-transitory computer-readable media storing computer-executable instructions that, when executed by the one or more processors, cause the one or more processors to perform operations comprising: operating in a first mode of operation while the network communication device detects a first environmental condition; receiving, at the network communication device, a notification of a second environmental condition; determining, by the network communication device and based on the second environmental condition, if the network communication device is to operate in a second mode of operation; and maintaining the first mode of operation if the network communication device determines the second mode of operation is not required based on the second environmental condition; and switching the network communication device from the first mode of operation to the second mode of operation upon the network communication device determining that the second environmental condition requires the second mode of operation.
17: The network communication device of paragraph 16, wherein: the first mode of operation is a lower power mode that provides a relatively lower bandwidth for communication, wherein the relatively lower bandwidth for communication comprises using a radio frequency transceiver; and the second mode of operation is a higher power mode that provides a relatively higher bandwidth for communication using a cellular transceiver or a satellite communication capable transceiver.
18: The network communication device of paragraph 16, wherein the first environmental condition comprises a battery operational condition whereby the network communication device uses a battery as a primary source of power to the network communication device.
19: The network communication device of paragraph 16, wherein the operations further comprise: registering a user equipment with the network communication device, wherein the registering comprises providing a location of the user equipment to the network communication device; wherein the first mode of operation is used by the network communication device when the user equipment is a distance greater than a predetermined radius or signal strength from the network communication device; and wherein the second mode of operation is used by the network communication device when the user equipment is a distance at or less than the predetermined radius or signal strength from the network communication device.
20: A non-transitory computer-readable media storing computer-executable instructions that, when executed by one or more processors, cause the one or more processors to perform operations comprising: operating a communication device in a first mode of operation while a network communication device detects a first environmental condition; receiving, at the network communication device, a notification of a second environmental condition, wherein the second environmental condition comprises a warning from a security device monitoring an area, wherein the security device comprises a camera or an audio sensor to monitor the area; switching the network communication device from the first mode of operation to a second mode of operation upon receiving the notification of the second environmental condition; and initializing a monitoring device to monitor an area based on the receiving the warning from the security device, wherein the monitoring device comprises a drone having a camera to provide images or video of the area. receiving, at the network communication device, a notification that the second environmental condition has cleared; and switching from the second mode of operation to the first mode of operation.

While the example clauses described above are described with respect to one particular implementation, it should be understood that, in the context of this document, the content of the example clauses can also be implemented via a method, device, system, computer-readable medium, and/or another implementation. Additionally, any of the examples A-S can be implemented alone or in combination with any other one or more of the examples A-S.

### Conclusion

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method of operating a network communication device, the method comprising:
operating in a first mode of operation while the network communication device detects a first environmental condition;
receiving, at the network communication device, a notification of a second environmental condition;
determining, by the network communication device and based on the second environmental condition, if the network communication device is to operate in a second mode of operation; and
maintaining the first mode of operation if the network communication device determines the second mode of operation is not required based on the second environmental condition; and
switching the network communication device from the first mode of operation to the second mode of operation upon the network communication device determining that the second environmental condition requires the second mode of operation.

2. The method of claim 1, wherein the first mode of operation is a lower power mode whereby the network communication device provides a relatively lower bandwidth for communication.

3. The method of claim 2, wherein the relatively lower bandwidth for communication comprises using a low power transceiver.

4. The method of claim 2, wherein the relatively lower bandwidth for communication comprises satellite communication.

5. The method of claim 4, wherein the satellite communication comprises satellite text messaging.

6. The method of claim 1, wherein the second mode of operation is a higher power mode whereby the network communication device provides a relatively higher bandwidth for communication.

7. The method of claim 6, wherein the relatively higher bandwidth for communication comprises using high power transceiver.

8. The method of claim 1, wherein the first environmental condition comprises a battery operational condition whereby the network communication device uses a battery as a primary source of power to the network communication device.

9. The method of claim 1, further comprising:
transmitting a notification to a user equipment to request permission to switch from the first mode of operation to the second mode of operation upon receiving the notification of the second environmental condition and determining that the second environmental condition requires the second mode of operation,
wherein the switching includes switching the network communication device from the first mode of operation to the second mode upon, in response to the notification to request permission, receiving a permission notification from the user equipment to permit the switching of the network communication device from the first mode of operation to the second mode of operation.

10. The method of claim 1, wherein the second environmental condition comprises a power source operational condition wherein the network communication device uses alternating current power or direct current power from a third-party power source.

11. The method of claim 1, further comprising:
registering a user equipment with the network communication device, wherein the registering comprises providing a location of the user equipment to the network communication device;
wherein the first mode of operation is used by the network communication device when the user equipment is a distance greater than a predetermined radius or signal strength from the network communication device; and
wherein the second mode of operation is used by the network communication device when the user equipment is a distance at or less than the predetermined radius or signal strength from the network communication device.

12. The method of claim 1, wherein the second environmental condition comprises a warning from a security device.

13. The method of claim 12, further comprising initializing a monitoring device to monitor an area based on the receiving the warning from the security device, wherein the monitoring device comprises a drone having a camera to provide images or video of the area.

14. The method of claim 13, wherein the monitoring device further comprises one or more audio or motion sensors to monitor the area.

15. The method of claim 1, further comprising:
receiving, at the network communication device, a notification that the second environmental condition has cleared; and
switching from the second mode of operation to the first mode of operation.

16. A network communication device, comprising:
one or more processors;
one or more transceivers; and
non-transitory computer-readable media storing computer-executable instructions that, when executed by the one or more processors, cause the one or more processors to perform operations comprising:
operating in a first mode of operation while the network communication device detects a first environmental condition;
receiving, at the network communication device, a notification of a second environmental condition;
determining, by the network communication device and based on the second environmental condition, if the network communication device is to operate in a second mode of operation; and
maintaining the first mode of operation if the network communication device determines the second mode of operation is not required based on the second environmental condition; and
switching the network communication device from the first mode of operation to the second mode of operation upon the network communication device determining that the second environmental condition requires the second mode of operation.

17. The network communication device of claim 16, wherein:
the first mode of operation is a lower power mode that provides a relatively lower bandwidth for communication, wherein the relatively lower bandwidth for communication comprises using a radio frequency transceiver; and
the second mode of operation is a higher power mode that provides a relatively higher bandwidth for communication using a cellular transceiver or a satellite communication capable transceiver.

18. The network communication device of claim 16, wherein the first environmental condition comprises a battery operational condition whereby the network communication device uses a battery as a primary source of power to the network communication device.

19. The network communication device of claim 16, wherein the operations further comprise:
registering a user equipment with the network communication device, wherein the registering comprises providing a location of the user equipment to the network communication device;
wherein the first mode of operation is used by the network communication device when the user equipment is a distance greater than a predetermined radius or signal strength from the network communication device; and
wherein the second mode of operation is used by the network communication device when the user equipment is a distance at or less than the predetermined radius or signal strength from the network communication device.

20. A non-transitory computer-readable media storing computer-executable instructions that, when executed by one or more processors, cause the one or more processors to perform operations comprising:
operating a communication device in a first mode of operation while a network communication device detects a first environmental condition;
receiving, at the network communication device, a notification of a second environmental condition, wherein the second environmental condition comprises a warning from a security device monitoring an area, wherein the security device comprises a camera or an audio sensor to monitor the area;
switching the network communication device from the first mode of operation to a second mode of operation upon receiving the notification of the second environmental condition; and
initializing a monitoring device to monitor an area based on the receiving the warning from the security device, wherein the monitoring device comprises a drone having a camera to provide images or video of the area;
receiving, at the network communication device, a notification that the second environmental condition has cleared; and
switching from the second mode of operation to the first mode of operation.
